(19) United States
(12) Patent Application Publication
(10) Pub. No.: US 2015/0081798 A1
(43) Pub. Date: Mar. 19, 2015

(54) PROCESS-BASED INTER-THING COLLABORATION APPARATUS AND METHOD IN WEB OF THINGS ENVIRONMENT

(71) Applicant: Electronics and Telecommunications Research Institute, Daejeon (KR)

(72) Inventors: Yong-Joon LEE, Daejeon (KR); Mal-Hee KIM, Daejeon (KR); Hyo-Chan BANG, Daejeon (KR)

(21) Appl. No.: 14/489,432

(22) Filed: Sep. 17, 2014

(30) Foreign Application Priority Data
Sep. 17, 2013 (KR) 10-2013-0111781
Mar. 20, 2014 (KR) 10-2014-0032760

(51) Int. Cl. H04L 12/24; H04L 29/08

(52) U.S. Cl. CPC H04L 41/0803; H04L 67/10
USPC 709/205

(57) ABSTRACT

Disclosed herein is a process-based inter-thing collaboration apparatus and method in a Web of Things (WoT) environment, which can perform dynamic collaboration between things in a WoT environment. The presented apparatus includes an inter-thing collaboration design tool unit for designing an Inter-Thing Collaboration Process (ITCP) based on information of things including a device, a service, and a process, and an inter-thing collaboration management unit for dynamically configuring an inter-thing collaboration community based on context information of the things, and executing the ITCP designed by the inter-thing collaboration design tool unit.

### CROSS REFERENCE TO RELATED APPLICATIONS

This application claims the benefit of Korean Patent Application Nos. 10-2013-0111781, filed on Sep. 17, 2013 and 10-2014-0032760, filed on Mar. 20, 2014, which are hereby incorporated by reference in their entirety into this application.

### BACKGROUND OF THE INVENTION

1. Technical Field

The present invention relates generally to a process-based inter-thing collaboration apparatus and method in a Web-of-Things (WoT)-environment and, more particularly, to an apparatus and method that allow things to autonomously collaborate with each other and achieve a specific goal in a WoT environment in which various things (sensor devices, services, and processes) are connected to the web.

2. Description of the Related Art

Web of things (WoT) technology is a technology for realizing the Internet of Things (IoT) by connecting the real world with various things (sensor devices and services) present in a virtual world to each other using web technology (Hypertext Markup Language: HTML, Uniform Resource Identifier: URI, Hypertext Transfer Protocol: HTTP, etc.).

Existing WoT technology provides URI for abstracting things into resources depending on the Representational State Transfer (REST) architecture style and identifying the resources, the structure of the resources, a method of representing the resources in various formats (HTML, Extensible Markup Language: XML, or JavaScript Object Notation: JSON) and connecting the resources via hyperlink, and an HTTP method (POST, GET, PUT, and DELETE)-based REST Application Programming Interface (API) for accessing (creating, reading, updating, and deleting) the resources.

Therefore, existing WoT technology is advantageous in that various things can be easily connected to the web, and a new mashup service can be created by combining (mashing up) the connected things. For example, data collected from a sensor device (thing) and data collected from a map service (thing) are collected and combined using a REST API, and then a new mashup service may be created via interaction with an actuator (thing).

However, existing mashup service technology provides a simple mashup function in which things are combined, but it is difficult to perform a complicated process for collaboration between things. For example, it is difficult to execute, monitor, and control a process requiring collaboration between things such as “When a diabetic patient measures blood sugar (task 1) using his or her smart phone, the smart phone searches (task 2) food information websites (thing B) for suitable food and checks food prices (task 3) from restaurant websites (thing C), unless a warning (event) such as a sudden rise in a blood sugar level is given from a glucose sensor (thing A), and thereafter recommends the closest and least expensive restaurant (task 4) with reference to the location data of the smart phone via a restaurant recommendation web (thing D). When the patient selects a preferable restaurant (thing E), the smart phone makes a reservation at the restaurant (task 5) if a reservation is possible, whereas recommends another restaurant (task 4) if a reservation is not possible.”

Further, it is difficult to provide a dynamic collaboration service considering the context information of things in existing mashup technology. In the above example, since a mashup service for making a reservation at a restaurant designates things to be used upon creating a program, it is difficult to implement dynamic collaboration capable of coping with exceptional situations (impossible reservation) that may occur in a collaboration procedure between various things (smart phone, food information and restaurant recommendation websites, an actuator, etc.).

Further, it is difficult to process events in a mashup service using a REST API. Schemes for collecting data from a sensor device include a request-response type synchronous scheme and an asynchronous scheme for sensing a frequently occurring event. Since the HTTP method of the REST API corresponds to the synchronous scheme, it is not efficient for event processing. For example, in order to sense an event such as “sudden rise in a blood sugar level” of a diabetic patient using the REST API, events must be periodically searched for.

As related preceding technology, technology which provides a media mashup platform for providing high-quality multimedia user experience to mobile device users is disclosed in U.S. Patent Application Publication No. 2011-0161409 (entitled “Media mashup system”). That is, the invention of U.S. Patent Application Publication No. 2011-0161409 provides a mashup model and a system structure for developing a media mashup service in which various sensors and content are combined in order to provide a high-quality content service.

As another related preceding technology, technology which describes workflow engine software capable of executing a web mashup service in a web browser is disclosed in U.S. Patent Application Publication No. 2010-0125826 (entitled “Workflow engine for execution of web mashups”). That is, the invention of U.S. Patent Application Publication No. 2010-0125826 interprets the definition of a web mashup service, generates execution code of components constituting the mashup, executes the code, and controls the execution sequence of the components.

### SUMMARY OF THE INVENTION

Accordingly, the present invention has been made keeping in mind the above problems occurring in the prior art, and an object of the present invention is to provide a process-based inter-thing collaboration apparatus and method in a WoT environment, which can perform dynamic collaboration between things in a WoT environment.

In detail, the object of the present invention is to provide a method of designing an Inter-Thing Collaboration Process (ITCP), a method of executing the designed ITCP via a RESTful web service and dynamically executing the process, a system structure capable of implementing the process design and execution method with high scalability and availability, and an inter-thing collaboration environment capable of being simply used by a user via a smart phone or the like in a movable environment.

In accordance with an aspect of the present invention to accomplish the above object, there is provided a process-based inter-thing collaboration apparatus in a WoT environment, including an inter-thing collaboration design tool unit for designing an ITCP based on information of things including a device, a service, and a process; and an inter-thing collaboration management unit for dynamically configuring an inter-thing collaboration community based on context information of the things, and executing the ITCP designed by the inter-thing collaboration design tool unit.

Preferably, the inter-thing collaboration design tool unit may include an ITCP modeler unit for modeling the ITCP and then generating an ITCP specification; and an ITCP execution plan generation unit for interpreting the ITCP specification generated by the ITCP modeler unit and then generating web service code.

Preferably, the process-based inter-thing collaboration apparatus may further include an application registration storage unit for storing the web service code generated by the ITCP execution plan generation unit.

Preferably, the inter-thing collaboration management unit may include an ITCP management engine unit for dynamically allocating things required to execute the web service code, and executing and monitoring the web service code; and a web service broker unit for binding a suitable service to the web service code in response to a request received from the ITCP management engine unit, and calling and executing a corresponding service via a web service interface.

Preferably, the ITCP management engine unit may be implemented in a distributed structure having a plurality of engines to perform collaboration.

Preferably, the ITCP specification may be a Business Process Modeling Notation (BPMN) process specification and is represented in a natural language or XML.

Preferably, the web service code may be RESTful web service code, and the ITCP execution plan generation unit may interpret the ITCP specification and then convert the ITCP specification into RESTful web service code written by a REST API.

Preferably, the process-based inter-thing collaboration apparatus may further include a thing registration storage unit for storing metadata of the things, a thing context information storage unit for storing context information of the things, and a thing resource storage unit for storing resource information of the things.

Preferably, the process-based inter-thing collaboration apparatus may further include a thing recommendation unit that recommend appropriate things by analyzing data of the thing registration storage unit and the thing context information storage unit.

Preferably, the process-based inter-thing collaboration apparatus may further include a context awareness unit for providing context information of the things to the inter-thing collaboration management unit with reference to data of the thing context information storage unit.

Preferably, the thing registration storage unit may have a data structure represented by a form of an Entity-Relationship (E-R) model, wherein the E-R model includes thing entity including device and virtual thing and having multiple resources, wherein the device entity includes sensor and actuator, and the virtual thing entity includes service and process, and wherein the service entity includes identifier (ID), function, input, and output attribute, the process entity includes ID, name, function, and flow attribute, and a task entity includes ID, function, input, and output attribute, and link to a task to be subsequently executed, and wherein the process entity and the task entity access the thing entity via the service entity.

Preferably, the thing context information storage unit may have a data structure represented by a form of an E-R model, wherein the E-R model includes a community entity having multiple members, each having context entity, wherein information of context includes 5 W (who, what, when, where and why) and rules for processing the SW information.

Preferably, the thing resource storage unit may have a data structure having a form of a resource tree represented by a URI, wherein the resource tree include thing resources having multiple thing-ID resources as children, the thing resource includes device resource, service resource, and process resource implemented in a form of a tree structure on the plurality of thing-ID resources, and the process resource includes task resource and event resource, and the device resource, the service resource, the process resource, the task resource, and the event resource are connected via hyperlink.

Preferably, the inter-thing collaboration community may include a plurality of things required to execute the ITCP and be configured such that a group allocated to a task of the ITCP is bound as things with reference to context information of the things.

Preferably, the device resource and the event resource may be represented in JSON.

Preferably, the task resource may be represented in HTML.

Preferably, the service resource may be represented in XML.

In accordance with another aspect of the present invention to accomplish the above object, there is provided a process-based inter-thing collaboration method in a WoT environment, including designing, by an inter-thing collaboration design tool unit, an ITCP based on information of things including a device, a service, and a process; and dynamically configuring, by an inter-thing collaboration management unit, an inter-thing collaboration community based on context information of the things, and executing the ITCP.

Preferably, designing the ITCP may include modeling the ITCP and then generating an ITCP specification; and interpreting the ITCP specification and then generating web service code.

Preferably, dynamically executing the ITCP may include dynamically allocating the things based on metadata of the things and the context information of the things; authenticating the dynamically allocated things and then configuring the inter-thing collaboration community; executing and monitoring the web service code within a space of the inter-thing collaboration community; and binding a suitable service to the web service code in response to a request received at monitoring, and calling and executing a corresponding service through a web service interface.

Preferably, the inter-thing collaboration community may include a plurality of things required to execute the ITCP, and is configured such that a group allocated to a task of the ITCP is bound as things with reference to context information of the things.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a configuration diagram showing a process-based inter-thing collaboration apparatus in a WoT environment according to an embodiment of the present invention;

FIG. 2 is a diagram showing the schematic configuration of an inter-thing collaboration model employed in an embodiment of the present invention;

FIG. 3 is a diagram showing an example of an ITCP employed in an embodiment of the present invention;

FIG. 4 is a diagram showing the configuration of a thing registration storage unit shown in FIG. 1;

FIG. 5 is a diagram showing the configuration of a thing context information storage unit shown in FIG. 1;

FIG. 6 is a diagram showing the configuration of a thing resource storage unit shown in FIG. 1;

FIGS. 7A to 7D are diagrams showing the resources of the thing resource storage unit shown in FIG. 1 in various forms;

FIG. 8 is a diagram showing a REST API employed in an embodiment of the present invention;

FIG. 9 is a flowchart showing the design procedure of a process-based inter-thing collaboration method in a WoT environment according to an embodiment of the present invention;

FIGS. 10 and 11 are diagrams employed in the description of FIG. 9;

FIG. 12 is a flowchart showing the execution procedure of the process-based inter-thing collaboration method in a WoT environment according to an embodiment of the present invention; and

FIG. 13 is a diagram employed in the description of FIG. 12.

### DESCRIPTION OF THE PREFERRED EMBODIMENTS

The present invention may be variously changed and may have various embodiments, and specific embodiments will be described in detail below with reference to the attached drawings.

However, it should be understood that those embodiments are not intended to limit the present invention to specific disclosure forms and they include all changes, equivalents or modifications included in the spirit and scope of the present invention.

The terms used in the present specification are merely used to describe specific embodiments and are not intended to limit the present invention. A singular expression includes a plural expression unless a description to the contrary is specifically pointed out in context. In the present specification, it should be understood that the terms such as “include” or “have” are merely intended to indicate that features, numbers, steps, operations, components, parts, or combinations thereof are present, and are not intended to exclude a possibility that one or more other features, numbers, steps, operations, components, parts, or combinations thereof will be present or added.

Unless differently defined, all terms used here including technical or scientific terms have the same meanings as the terms generally understood by those skilled in the art to which the present invention pertains. The terms identical to those defined in generally used dictionaries should be interpreted as having meanings identical to contextual meanings of the related art, and are not interpreted as being ideal or excessively formal meanings unless they are definitely defined in the present specification.

Embodiments of the present invention will be described in detail with reference to the accompanying drawings. In the following description of the present invention, the same reference numerals are used to designate the same or similar elements throughout the drawings and repeated descriptions of the same components will be omitted.

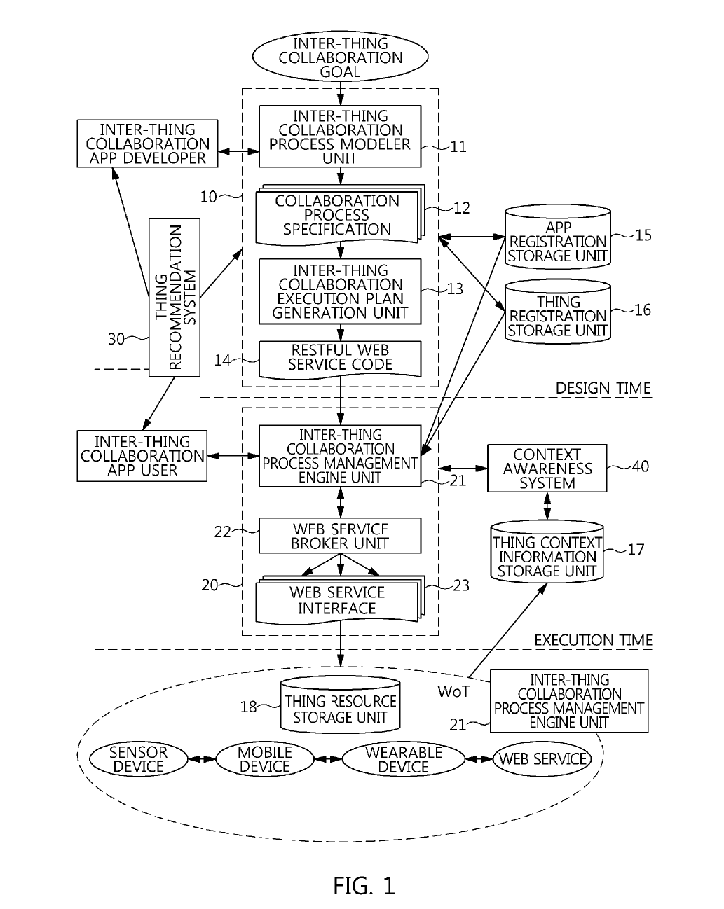

FIG. 1 is a diagram showing the configuration of a process-based inter-thing collaboration apparatus in a WoT environment according to an embodiment of the present invention.

The process-based inter-thing collaboration apparatus in a WoT environment according to the embodiment of the present invention includes an inter-thing collaboration design tool unit 10 and an inter-thing collaboration management unit 20.

The inter-thing collaboration design tool unit 10 designs an ITCP. Preferably, the inter-thing collaboration design tool unit 10 may include an ITCP modeler unit 11 and an ITCP execution plan generation unit 13. Here, the ITCP modeler unit 11 may model an ITCP and generate ITCP specifications 12 written in BPMN. The ITCP execution plan generation unit 13 may interpret the ITCP specifications 12 generated by the ITCP modeler unit 11 and generate RESTful web service code 14 written using a REST API.

Meanwhile, the RESTful web service code 14 generated by the ITCP execution plan generation unit 13 may be registered in an Application (App) registration storage unit 15. In FIG. 1, although the inter-thing collaboration design tool unit 10 and the App registration storage unit 15 are shown as separate components, the App registration storage unit 15 may be contained in the inter-thing collaboration design tool unit 10.

The inter-thing collaboration management unit 20 configures an inter-thing collaboration community so as to dynamically execute the ITCP designed by the inter-thing collaboration design tool unit 10. Preferably, the inter-thing collaboration management unit 20 may include an ITCP management engine unit 21 and a web service broker unit 22. Here, the ITCP management engine unit 21 may execute, monitor, and control RESTful web service code 14 that is either stored in the App registration storage unit 15 or generated by the ITCP modeler unit 11. That is, the ITCP management engine unit 21 may dynamically allocate things required to execute the RESTful web service code 14, and execute and monitor the RESTful web service code 14. The web service broker unit 22 may bind a suitable service to the RESTful web service code in response to a request received from the ITCP management engine unit 21, and may call and execute a service through a web service interface 23. In other words, the above-described inter-thing collaboration management unit 20 may configure an inter-thing collaboration community based on the resource information of things and the dynamic information of the things and may dynamically execute the ITCP generated by the inter-thing collaboration design tool unit 10.

Meanwhile, the above-described ITCP management engine unit 21 has a distributed structure to improve scalability and availability, and is configured such that a plurality of engines may be installed in a server or things (devices). That is, the ITCP management engine unit 21 may be regarded as being designed (configured) in a distributed structure having a plurality of engines so as to execute collaboration.

In FIG. 1, the thing recommendation system 30 may provide the function of analyzing the data of a thing registration storage unit 16 and a thing context information storage unit 17 and recommending suitable thing to an App developer who uses the inter-thing collaboration design tool unit 10 and App users who use the inter-thing collaboration management unit 20.

Further, a context awareness system 40 shown in FIG. 1 provides the context information of things to the inter-thing collaboration management unit 20 with reference to the data of the thing context information storage unit 17.

In FIG. 1, although the thing recommendation system 30 and the context awareness system 40 are shown as components independent of the process-based inter-thing collaboration apparatus in a WoT environment according to the embodiment of the present invention, they may be included as internal components in the process-based inter-thing collaboration apparatus in a WoT environment according to the embodiment of the present invention. That is, the thing recommendation system 30 may be a thing recommendation unit described in the accompanying claims of the present invention, and the context awareness system 40 may be a context awareness unit described in the claims.

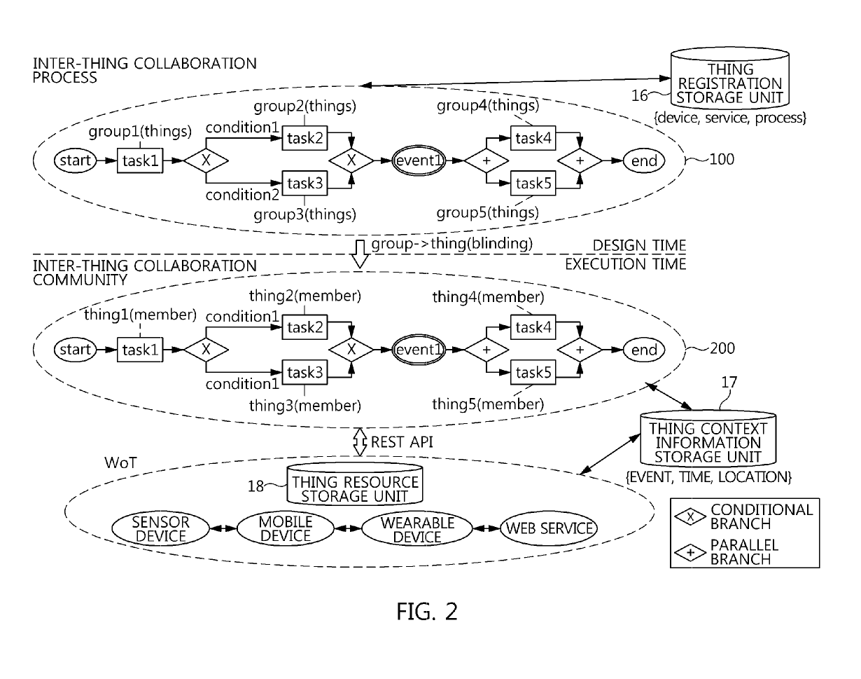

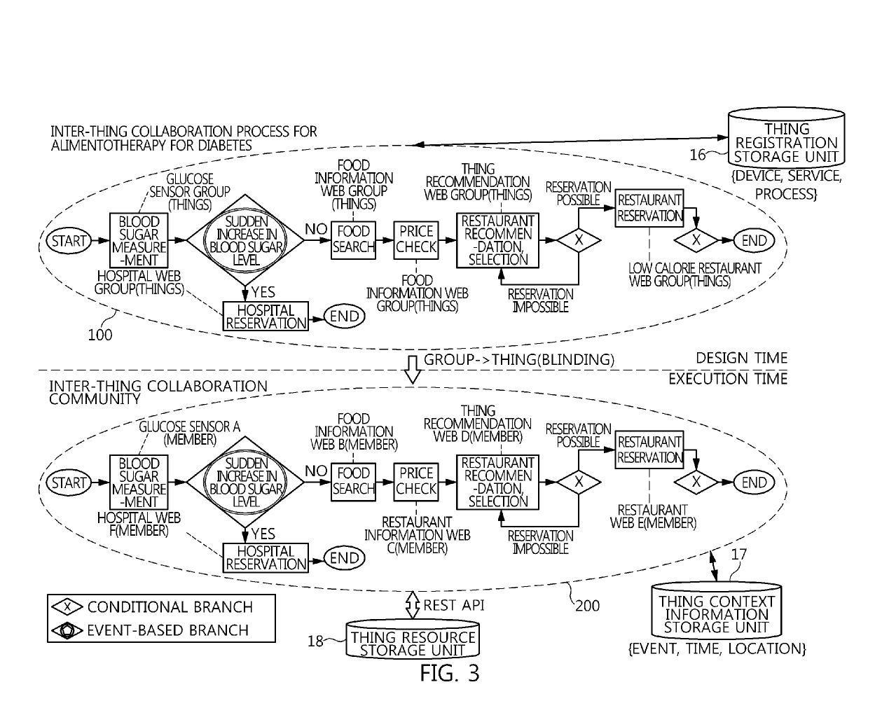

FIG. 2 is a diagram showing the schematic configuration of an inter-thing collaboration model employed in an embodiment of the present invention, and FIG. 3 is a diagram showing an example of an ITCP employed in an embodiment of the present invention. The same reference numerals are assigned to components identical to those described in FIG. 1. Upon performing the process-based RESTful inter-thing collaboration according to the embodiment of the present invention, the schematic configuration of the inter-thing collaboration model will be described below.

In FIG. 2, the thing registration storage unit 16 stores the metadata of sensor devices, services, processes, etc. as static information about things. Preferably, the thing registration storage unit 16 may store metadata (for example, ID, function, input, output, etc.) about each service or the like.

The thing context information storage unit 17 stores events, times, location information, etc. collected from individual things as dynamic information about the things. In this way, pieces of information stored in the thing context information storage unit 17 may be regarded as the context information of each thing.

A thing resource storage unit 18, which is a storage that stores thing information as resources identifiable by URI in the WoT environment and that is accessed by the REST API, is connected to the metadata of the thing registration storage unit 16. For example, the metadata (ID, name, manufacturer, and function) of each sensor device is stored in the thing registration storage unit 16, but sensor data collected from the sensor device is stored in the thing resource storage unit 18, and is read and updated via the REST API. Preferably, the thing resource storage unit 18 may store web service specifications (URIs, methods, parameters, etc.).

The above-described thing registration storage unit 16, the thing context information storage unit 17, and the thing resource storage unit 18 may also be understood to be the components of the process-based inter-thing collaboration apparatus in the WoT environment according to the embodiment of the present invention.

The inter-thing collaboration model presented in FIG. 2 includes an ITCP 100 and an inter-thing collaboration community 200. Preferably, the inter-thing collaboration model includes a design time at which the ITCP 100 is defined as a BPMN process with reference to the data of the thing registration storage unit 16, and an execution time at which the inter-thing collaboration community 200 is dynamically configured with reference to the data of the thing context information storage unit 17 and the thing resource storage unit 18 and executes the ITCP in the WoT environment.

A process represented by BPMN in the ITCP 100 may include tasks (for example, a normal task automatically executed by a system, a service task requiring both input/output messages, a reception task requiring an input message, a transmission task requiring an output message, a user task executed by a person with the help of a predefined application, a script task enabling a script supported by the system to be executed, a manual task executed by a person without help of the system, a reference task enabling a predefined task to be referred to, etc.), events indicating the behavior of accidents occurring during a process, flows (for example, a sequential flow indicating the flow of internal objects of the process, a message flow indicating the flow of entities between processes, etc.), and gateway (branch) components for determining the flow of each process.

The ITCP 100 of FIG. 2 is a process in which, after task 1 has been executed, task 2 or task 3 is executed depending on the condition, and in which, when event 1 occurs subsequently, task 4 and task 5 are simultaneously executed and terminated. Groups taking charge of execution are allocated to respective tasks, and each group is a set of things which perform a specific function.

In the ITCP 100 of FIG. 2, a group, which is a set of things performing the function required to execute each task, is allocated to the task.

Meanwhile, the inter-thing collaboration community 200 of FIG. 2 may be composed of a plurality of members (things) for executing the process. In this case, the inter-thing collaboration community 200 binds each group allocated to each task of the ITCP 100 as things (members), with reference to the data of the thing context information storage unit 17.

An example of the ITCP based on the inter-thing collaboration model of FIG. 2 will be presented below. That is, an alimentotherapy collaboration process for diabetic patients may be presented as an example, as shown in FIG. 3.

The alimentotherapy collaboration process for diabetic patients is implemented such that a “glucose sensor group” is allocated to a blood sugar measurement task at a design time, and “low calorie restaurant group” is allocated to a restaurant reservation task. Further, at an execution time, the group is bound to “available glucose sensor A” and “closest and least expensive restaurant E (thing)” with reference to context information.

After binding has been completed, the inter-thing collaboration community 200 accesses the thing resource storage unit 18 via the REST API, and then executes the process.

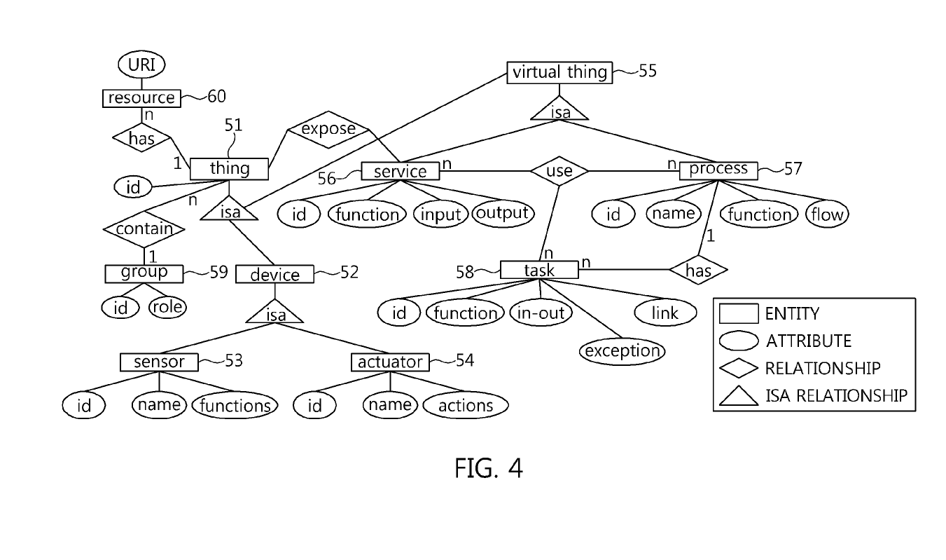

FIG. 4 is a diagram showing the configuration of the thing registration storage unit shown in FIG. 1 and illustrates an E-R model representing the thing registration storage unit 16, upon executing the process-based RESTful inter-thing collaboration according to an embodiment of the present invention.

In FIG. 4, a thing 51 is composed of a device 52 and a virtual thing 55, a device 52 is composed of a sensor 53 and an actuator 54, and the virtual thing 55 is composed of a service 56 and a process 57.

The service 56 is an interface for abstracting and accessing (reading, updating, or deleting) the thing 51, wherein the thing registration storage unit 16 stores the metadata (ID, function, input, and output) of the service, and the thing resource storage unit 18 stores web service specifications (URIs, methods, and parameters).

The process 57 has items such as an ID, a name, a function, and a flow required to control the flow of the process, and is implemented as a set of tasks 58.

Each task 58 includes items such as an ID, a function, input, output, a link (URI) to a task to be subsequently executed, and exception handling.

The process 57 and the task 58 access the thing 51 through the service 56. A group 59 has a role and includes a plurality of things 51. Each thing 51 has a plurality of resources 60.

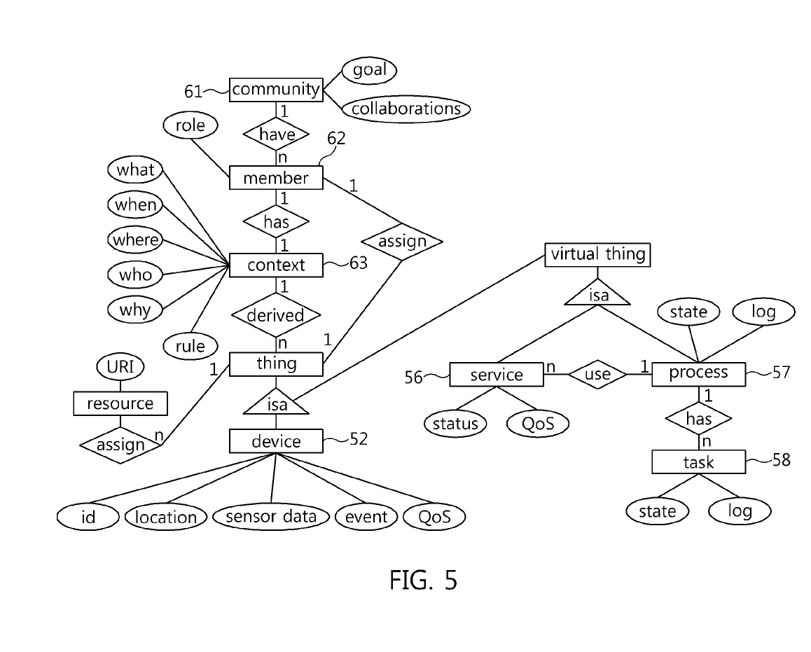

FIG. 5 is a diagram showing the configuration of the thing context information storage unit 17 shown in FIG. 1, and illustrates an E-R model representing the thing context information storage unit 17 upon the process-based RESTful inter-thing collaboration according to an embodiment of the present invention.

A community 61 has a plurality of members 62, and each member 62 has context 63.

The information of the context 63 is extracted by integrating and analyzing the context data of the device 52 (for example, location, sensor data, event, and Quality of Service: QoS), the context data of the service 56 (for example, status and QoS), and the context data of the process 57 (for example, state and log). Preferably, the information of the context 63 is composed of 5 W information (who, what, when, where, and why) and rules required to process the 5 W information. The QoS denotes information indicating the current state and service quality of a thing, and includes, for example, a device state, service, process traffic, etc.

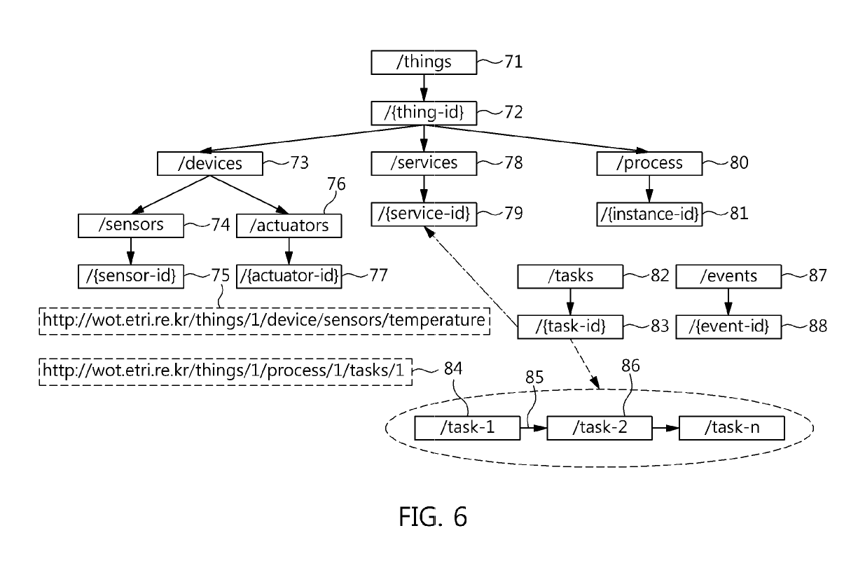

FIG. 6 is a diagram showing the configuration of the thing resource storage unit 18 shown in FIG. 1, and illustrates a resource tree that represents the structure of the thing resource storage unit 18 by a URI upon performing the process-based RESTful inter-thing collaboration according to an embodiment of the present invention.

Parent resource, that is, /things 71, have multiple things, that is, /{thing-id} 72, as children, and individual nodes 73 to 88 constituting the resource tree may be connected via hyperlink 85. In particular, /process 80 which is resource includes child resources /{instance-id} 81, /tasks 82, and /{task-id} 83, wherein task-1 84 has a URI and is connected to /task2 86 via hyperlink 85.

The URI “http ://wot.etri.re.kr/things/1/device/sensors/temperature” of the resource “/(sensor-id) 75”, that is, child resource of “/sensors 74”, represents a sensor having a sensor-id indicative of ‘temperature’ of a device belonging to things 1.

Since the resource, that is, /{instance-id} 81, may be executed by various users in spite of the same process, process instances are allocated to respective users so as to solve such a problem. For example, after /things/1/process/2/tasks/1 (task 1 of process 2 of things 1) has been executed, /task-2 and /task-n connected via hyperlink are sequentially executed. In this case, various events may occur in /{instance-id} 81, and thus /events 87 have a plurality of event IDs, that is,/{event-id} 88, as children.

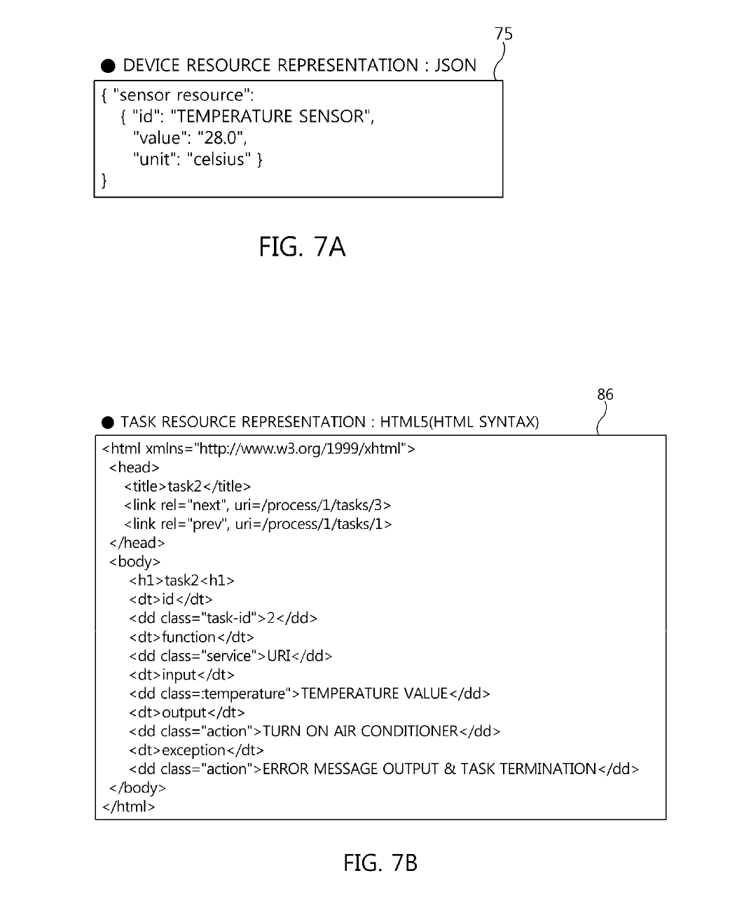

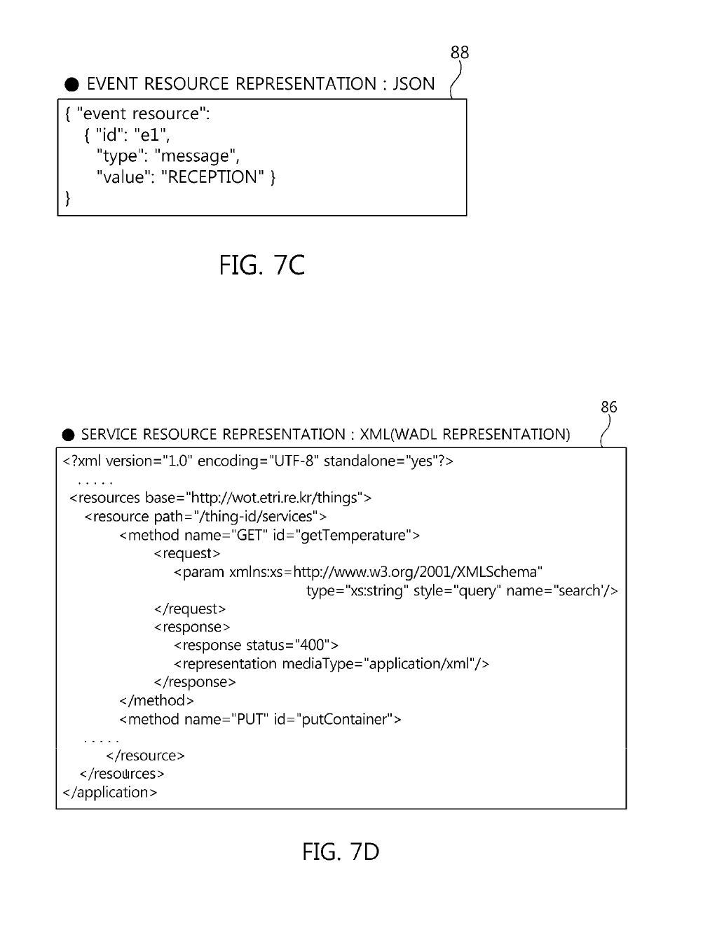

FIGS. 7A to 7D are diagrams representing the resources of the thing resource storage unit 18 shown in FIG. 1 in various forms, and illustrate examples in which the resources of the thing resource storage unit 18 are represented in various forms upon performing the process-based RESTful inter-thing collaboration according to an embodiment of the present invention.

Among the resources of the thing resource storage unit 18, the data of sensor resource 75 may be represented in JSON, as shown in FIG. 7A.

Among the resources of the thing resource storage unit 18, the data of task resource 86 may be represented in HTML, as shown in FIG. 7B. Meanwhile, among the resources of the thing resource storage unit 18, hyperlink may also be represented in HTML.

Further, among the resources of the thing resource storage unit 18, event resource 88 may be represented in JSON, as shown in 7C.

Among the resources of the thing resource storage unit 18, the data of service resource 79 may be represented in XML (for example, Web Access Description Language: WADL), as shown in FIG. 7D. That is, the service resource 79 may be represented, as shown in FIG. 7D, with reference to metadata 56 about the service of FIG. 4.

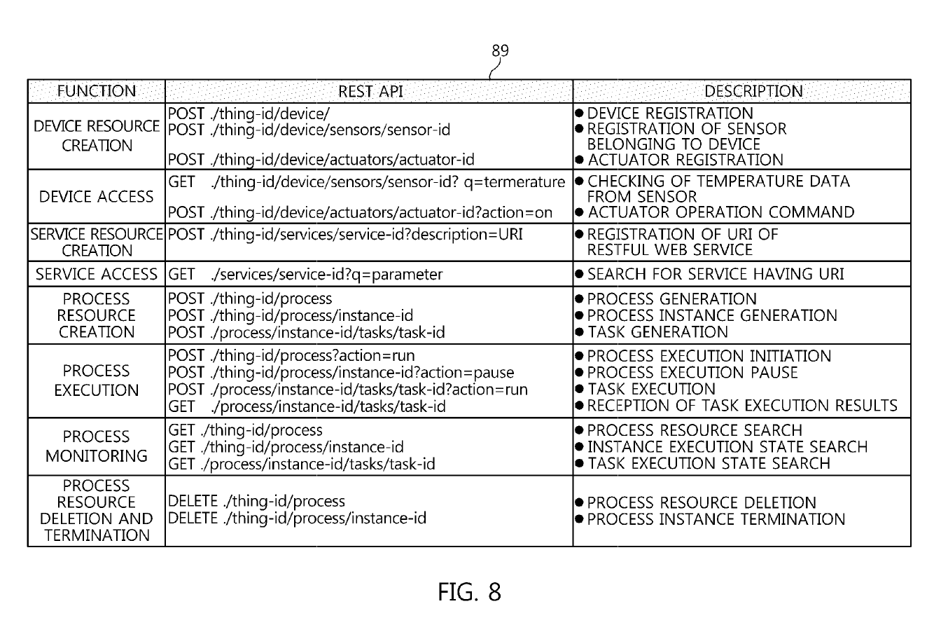

FIG. 8 is a diagram showing a REST API employed in an embodiment of the present invention, and illustrates the design of a thing resource interface, that is, a REST API 89, upon performing the process-based RESTful inter-thing collaboration according to an embodiment of the present invention.

FIG. 8 specifies an HTTP method-based REST API for registering and accessing resources (devices, services, and processes) depending on the structure of the thing resources of FIG. 6 and the representation and connection schemes of the thing resources of FIGS. 7A to 7D.

According to the above-described present invention, an ITCP is designed using BPMN which is an Object Management Group (OMG) international standard, and the designed ITCP (for example, a BPMN process) is converted into a RESTful web service and then executed. Below, a process-based inter-thing collaboration method in a WoT environment according to an embodiment of the present invention will be described in greater detail.

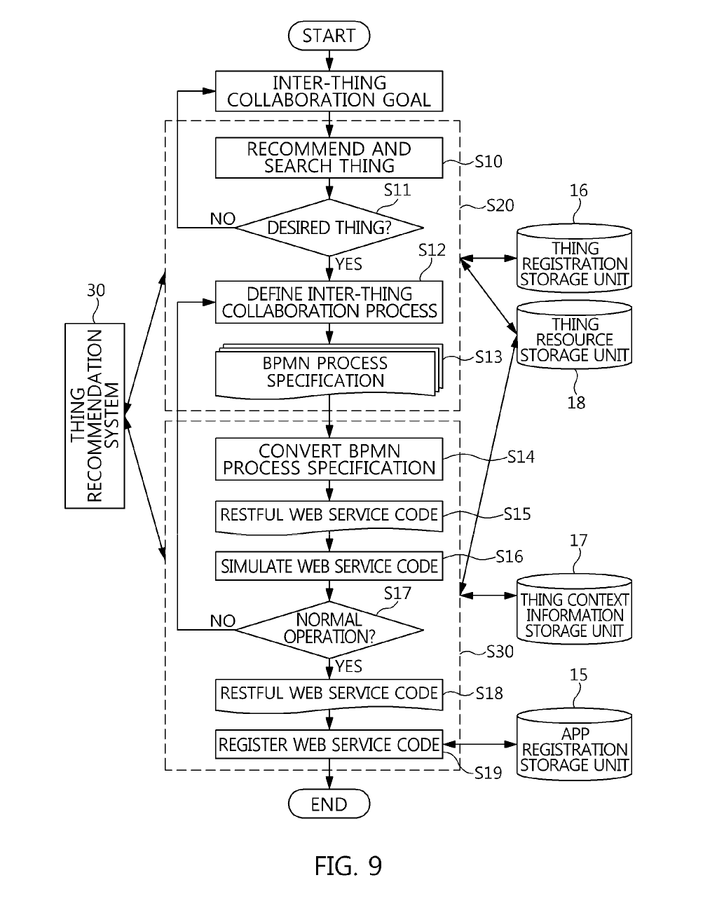

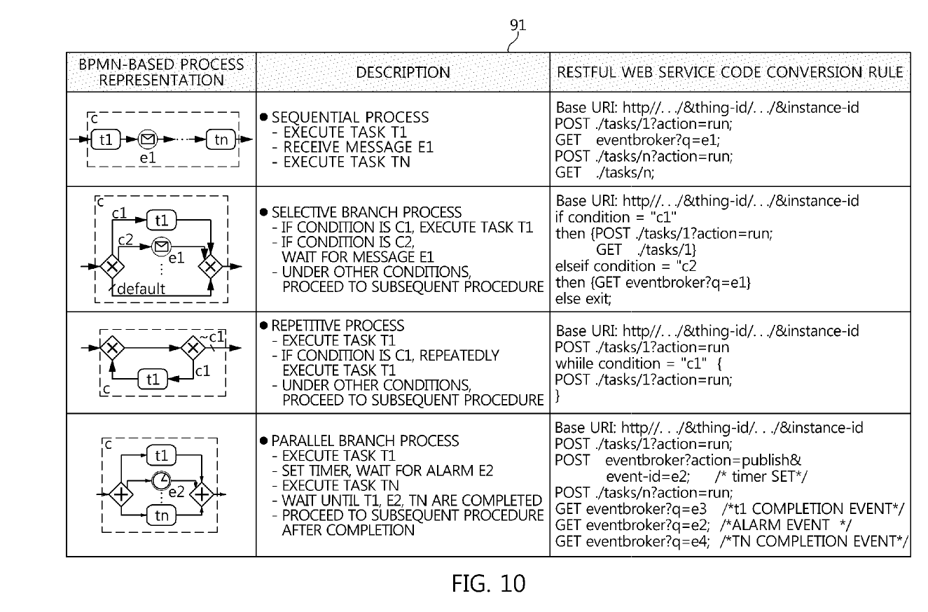

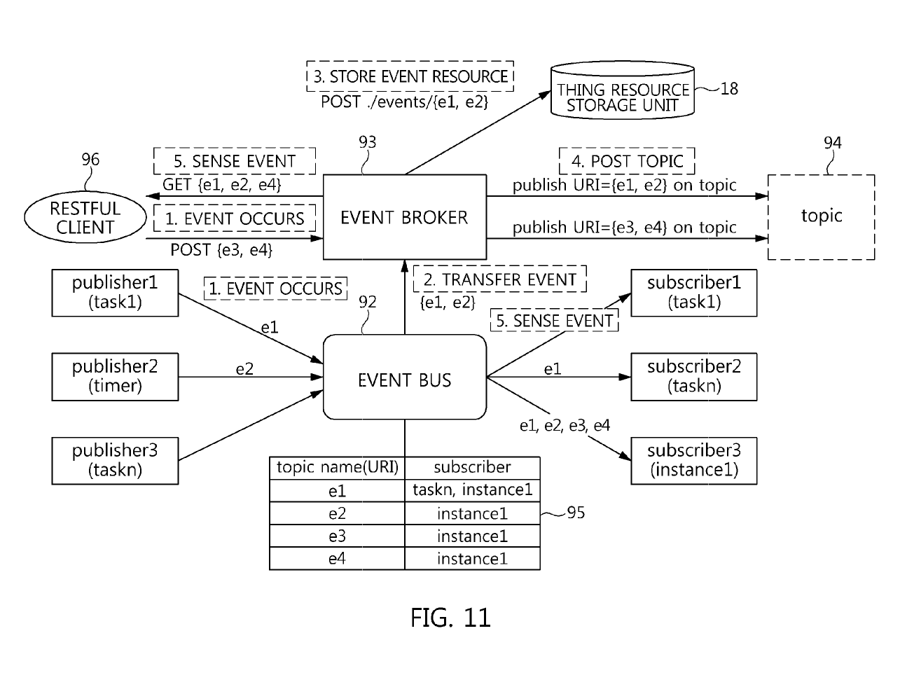

First, the design procedure of the process-based inter-thing collaboration method in a WoT environment according to the embodiment of the present invention will be described with reference to the flowchart of FIG. 9. FIGS. 10 and 11 are diagrams employed in the description of FIG. 9.

Hereinafter, the design procedure of the process-based inter-thing collaboration method in the WoT environment may be regarded as the processing flow of the inter-thing collaboration design tool unit 10 of FIG. 1, and is assumed to describe the flow of processing in which an ITCP for practicing alimentotherapy for diabetic patients is designed and an application (App) is developed using the process.

First, an URI is assigned to connect existent things (devices, services, etc.) via the web, the information of things is registered in the thing resource storage unit 18, and the metadata of things is registered in the thing registration storage unit 16 for searching and recommendation.

An inter-thing collaboration App developer inputs the target or object of inter-thing collaboration (for example, alimentotherapy management for diabetic patients) to the ITCP modeler unit 11.

Accordingly, the ITCP modeler unit 11 shows the results of recommendation suitable for a goal by the thing recommendation system 30 to the inter-thing collaboration App developer at step S10.

When the inter-thing collaboration App developer selects a desired thing (group) (Yes at step S11), the ITCP modeler unit 11 shows the information of the thing registration storage unit 16 (for example, a smart phone, a health device, service information required to access food information and restaurant websites, etc.).

If there is no suitable thing (group), the inter-thing collaboration App developer re-inputs a goal and searches for and selects a desired thing (group).

In this way, the ITCP modeler unit 11 shows the results of recommendation of a process (thing) suitable for the achievement of the goal to the inter-thing collaboration App developer. If the inter-thing collaboration App developer selects a desired process, the ITCP modeler unit 11 shows the process information 57 of the thing registration storage unit 16 (for example, an exception handling process or the like). Of course, if there is no suitable process, the inter-thing collaboration App developer searches again for a process or proceeds to a subsequent step.

Thereafter, the ITCP modeler unit 11 mashes up things (groups) selected by the inter-thing collaboration App developer and defines a BPMN-based ITCP at step S12, and generates a BPMN process specification at step S13. Here, the BPMN process specification may be represented in a natural language or XML so that it can be easily understood by the inter-thing collaboration App developer. For example, “alimentotherapy process for diabetes” is represented in BPMN. Further, as shown in FIGS. 2 and 3, groups registered in FIG. 4 are allocated to respective tasks.

Then, the ITCP execution plan generation unit 13 interprets the BPMN process specification (also referred to as “ITCP specification”) generated by the ITCP modeler unit 11, and converts the specification into RESTful web service code written by the REST API at steps S14 and S15. FIG. 10 illustrates the RESTful web service conversion rules 91 of the BPMN process. In detail, a sequential process, a selective branch process, a repetitive process, and a parallel branch process represented in BPMN are converted into RESTful web service code using the RESTful web service conversion rules 91.

Upon performing conversion into the RESTful web service code, thing variables corresponding to a group, rather than a thing (thing-id), are designated in the code in the form of a Base URI. For example, Base URI is designated in the form of “http:// . . . /&thing-id/ . . . /&instance-id.” At the execution time of the code, the variable ‘&thing-id’ is converted into ‘thing-id’ of an allocated thing by the inter-thing collaboration management unit 20.

Further, “GET eventbroker” which is a new REST API capable of sensing an event in the selective branch process of the RESTful web service conversion rules 91 is provided, and rules required to convert a BPMN event into a web service using “GET eventbroker” are provided. The processing flow of “GET eventbroker” will be described in detail with reference to FIG. 11. An event broker 93 is provided which processes events in a RESTful manner while operating in conjunction with an event bus 92 for processing events and messages in an existing publisher-subscriber manner. Here, the event bus 92 refers to information 95 related to a topic name and a subscriber. For example, when an event occurs from a publisher, the event bus 92 transfers the event to the event broker 93, and the event broker 93 assigns a URI to the event, stores the event in the thing resource storage unit 18, and posts the event as a topic 94. Therefore, a RESTful client 96 can sense (GET) the event posted as the topic 94 through the REST API, and post events as topics 94 to allow other subscribers to sense the posted events.

The event processing flow of FIG. 11 will be described below as an example, with reference to FIG. 10. First, in the sequential process of FIG. 10, “subscriber taskn” in FIG. 11 may receive a message (event) e1, posted as a topic by “publisher task1”, by executing “GET eventbroker?q=e1.” In the parallel branch process of FIG. 10, “subscriber instance” of FIG. 11, that is, the parallel branch process currently being executed, may receive events e3 and e4 posted (POST {e3,e4}) by task1 and taskn via the event broker 93 by executing “GET eventbroker?q={e3,e4}.”

In this way, RESTful web service code is generated from the alimentotherapy process represented in BPMN by using the RESTful web service conversion rules 91 of the BPMN process of FIG. 10.

Thereafter, the ITCP execution plan generation unit 13 tests whether the RESTful web service code is normally operated using a simulator at step S16.

If an error occurs in the RESTful web service code, the process definition step S12 is re-performed, and the test is repeated until the RESTful web service code is normally operated.

If the RESTful web service code is normally operated (Yes at step S 17), the process proceeds to a subsequent registration step. That is, the ITCP execution plan generation unit 13 registers resources (processes, instances, tasks) constituting the RESTful web service code for restaurant reservation in the thing resource storage unit 18. Further, the ITCP execution plan generation unit 13 registers the metadata of resources constituting the RESTful web service code in the thing registration storage unit 16. Furthermore, the ITCP execution plan generation unit 13 registers web service code for “restaurant reservation for diabetic patients” in the App registration storage unit 15 at steps S18 and S19.

In FIG. 9, S20 denotes the flow of processing performed by the ITCP modeler unit 11 of the inter-thing collaboration design tool unit 10, and S30 denotes the flow of processing performed by the ITCP execution plan generation unit 13 of the inter-thing collaboration design tool unit 10.

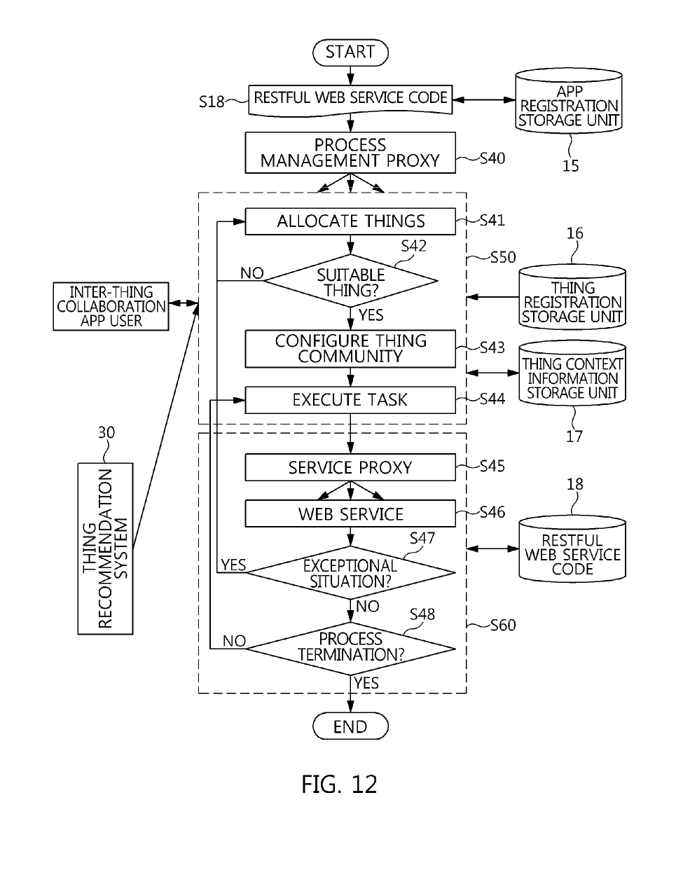

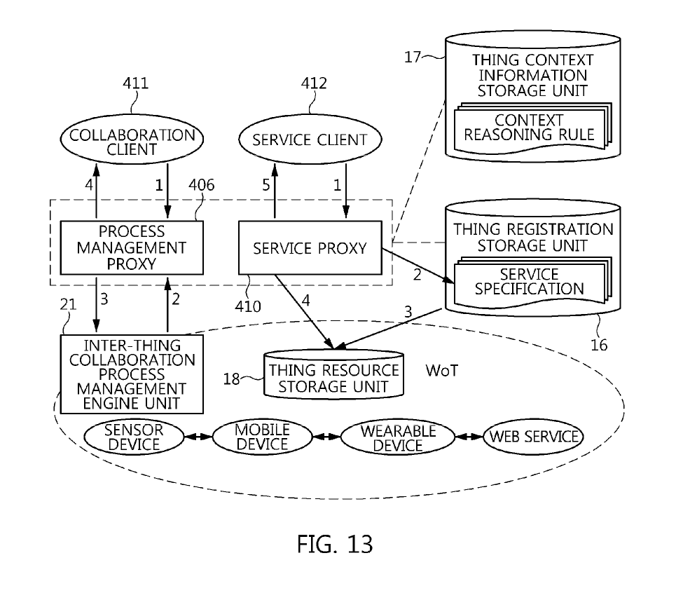

Below, the execution procedure of the process-based inter-thing collaboration method in a WoT environment according to an embodiment of the present invention will be described in detail with reference to the flowchart of FIG. 12. FIG. 13 is a diagram employed in the description of FIG. 12.

The execution procedure of the process-based inter-thing collaboration method in the WoT environment, which will be described below, may be regarded as the flow of processing by the inter-thing collaboration management unit 20 of FIG. 1, and is assumed to describe the flow of processing in which an ITCP for practicing alimentotherapy for chronic patients is executed using an application (App).

An inter-thing collaboration App user (diabetic patient) downloads an “inter-thing collaboration App for restaurant reservation”) from the App registration storage unit 15 via a smart phone, and executes the downloaded App. The inter-thing collaboration App accesses a process management proxy 406 (see FIG. 13) so as to determine an ITCP management engine unit 21 on which the App is to be executed at step S40.

Accordingly, if the process management proxy 406 analyzes the context information (for example, location, QoS, etc.) of things constituting the App, and allocates an ITCP management engine unit 21 suitable for the execution of the App, the App is connected to the allocated ITCP management engine unit 21. FIG. 13 illustrates the processing flow of the process management proxy 406, wherein a collaboration client 411, that is, the inter-thing collaboration App, makes an execution request through the process management proxy 406 without directly requesting execution from the ITCP management engine unit 21, and the process management proxy 406 internally instructs a suitable ITCP management engine unit 21 to execute the App, and transfers the results of the execution to the collaboration client 411, thus improving scalability and availability.

In this way, the ITCP management engine unit 21 is connected to the thing recommendation system 30 and is then recommended a thing suitable for the execution of the App at step S41. In other words, the thing must belong to a group designated in the task in the above-described design procedure. The ITCP management engine unit 21 shows the results of suitable recommendation by the thing recommendation system 30 to the App user. When the user selects a desired thing, the ITCP management engine unit 21 shows the information of the thing registration storage unit 16 (for example, the recommendation and selection of the closest and least expensive restaurant E which provides suitable food menus). Meanwhile, in the case of “App for an emergency” which does not require the recommendation and selection of things, the ITCP management engine unit 21 automatically selects a suitable thing (for example, in an emergency of a diabetic patient, notification of emergency to the closest emergency medical center F and taking emergency measures) with reference to the thing context information storage unit 17. In this way, the ITCP management engine unit 21 allocates (binds) a user-selected thing or an automatically selected thing to the RESTful web service code.

Thereafter, the ITCP management engine unit 21 authenticates suitably allocated things at step S42, configures a community space for collaboration, and forces the things to join the community as members at step S43. The members in the thing community space may reliability share resources with each other. The ITCP management engine unit 21 assigns a URI to the things of the RESTful web service code using the allocated things, and thus completes the code. For example, the code <searching for low calorie restaurant group→restaurant reservation> is converted into the code <searching for restaurant E (URI) closest to current location (URI)→restaurant E reservation>.

Then, the ITCP management engine unit 21 monitors the tasks of the RESTful web service code in the thing community space while sequentially executing the tasks. If access to things is required during the execution of the tasks, the engine unit 21 requests the service proxy 410 (see FIG. 13) to call the corresponding service. The ITCP management engine unit 21 normally executes the service through the service proxy 410, and executes a subsequent task unless the process is terminated at step S44.

FIG. 13 is a diagram showing the detailed processing flow of the service proxy 410. For example, when a task for making a reservation at restaurant E makes a reservation request through the service proxy 410, the service proxy 410 searches the thing registration storage unit 16 for “reservation service”, calls and executes a web service with reference to the information of service resource 88 stored in the thing resource storage unit 18, and transfers the results of the execution to the task. In this way, access to things is provided, and thus things may be abstracted and may be accessed through a common interface regardless of the type of things at step S45 and S46.

Meanwhile, when the service proxy 410 senses an exceptional situation during the execution of the web service (for example, impossible to make a reservation at restaurant E), the service proxy 410 receives the current situation (context information) from the thing context information storage unit 17, and notifies the user of the current situation. Accordingly, the ITCP management engine unit 21 re-executes the task by binding other things to the RESTful web service code. For example, code <food X selection→searching for restaurant E→reservation>is converted into <food Y selection→searching for restaurant G→reservation>.

In contrast, if the process is terminated without causing an exceptional situation (No at step S47, and Yes at step S48), the execution procedure of the process-based inter-thing collaboration method in the WoT environment is terminated.

In the above-described FIG. 12, S50 denotes the flow of processing performed by the ITCP management engine unit 21 of the inter-thing collaboration management unit 20 and S60 denotes the flow of processing performed by the web service broker unit 22 of the inter-thing collaboration management unit 20.

In accordance with the present invention having the above configuration, there can be provided the process-based inter-thing collaboration method and system structure, which support a Web of Everything (WoE) environment in which devices, data, and processes are closely bound to collaborate with each other, by evolving from an existing mashup scheme in which devices and services (data) are simply mashed up to collaborate with each other in a WoT environment. In detail, complicated ITCP(a sequential process in which devices and services are connected, a selective branch process, a repetitive process, a parallel process, and event processing) may be conveniently designed using BPMN which is a standard process language, and may be implemented as RESTful web services. For example, when it is desired to implement the business process (production, sales, and distribution) of businesses in the WoT environment, it may be easily modeled as a BPMN process and may be easily implemented as a web service associated with an existing information system.

Further, the present invention provides a method and system structure for binding (allocating) things necessary for execution of an ITCP in an execution procedure without binding (allocating) the things in a design procedure, thus allocating suitable things depending on context information. Accordingly, the present invention can perform efficient inter-thing collaboration and flexibly cope with the occurrence of exceptional situations. For example, inter-thing collaboration can be desirably performed by replacing current things with other things or allocating other things when a location-based inter-thing collaboration service is developed, or when a fault or trouble occurs in things.

Furthermore, the present invention provides a RESTful inter-thing collaboration method and a proxy-based distributed inter-thing collaboration system structure, thereby guaranteeing high performance, scalability, and availability in a WoT environment in which a large number of things will be connected and will collaborate with each other in the future. In detail, in order to execute a collaborative process, a light-weight RESTful ITCP management system that can be installed even in a device (smart phone) having a limited computing ability can be implemented, without having to use a heavy server-based Business Process Management (BPM) engine, and a plurality of inter-thing collaboration systems can be provided through a proxy.

Further, the present invention can provide the advantages of both a server-based centralized scheme and an agent (autonomous and intelligent software)-based Peer-to-Peer (P2P) scheme. In detail, a large-scale RESTful process management system can be installed in a server, a light-weight RESTful process system (agent) can be installed in each device, and a proxy can select a process management system and an agent suitable for the execution of a process, thus enabling distributed processing to be performed.

In embodiments, aspects of this disclosure may be performed by a computer device with a processor and memory. In addition, aspects of the disclosure may be stored on a computer readable medium such as a magnetic disk, a solid state drive, etc.

As described above, optimal embodiments of the present invention have been disclosed in the drawings and the specification. Although specific terms have been used in the present specification, these are merely intended to describe the present invention and are not intended to limit the meanings thereof or the scope of the present invention described in the accompanying claims. Therefore, those skilled in the art will appreciate that various modifications and other equivalent embodiments are possible from the embodiments. Therefore, the technical scope of the present invention should be defined by the technical spirit of the claims.

What is claimed is:

1. A process-based inter-thing collaboration apparatus in a Web of Things (WoT) environment, comprising:
an inter-thing collaboration design tool unit for designing an Inter-Thing Collaboration Process (ITCP) based on information of things including a device, a service, and a process; and
an inter-thing collaboration management unit for dynamically configuring an inter-thing collaboration community based on context information of the things, and executing the ITCP designed by the inter-thing collaboration design tool unit.

2. The process-based inter-thing collaboration apparatus of claim 1, wherein the inter-thing collaboration design tool unit comprises:
an ITCP modeler unit for modeling the ITCP and then generating an ITCP specification; and
an ITCP execution plan generation unit for interpreting the ITCP specification generated by the ITCP modeler unit and then generating web service code.

3. The process-based inter-thing collaboration apparatus of claim 2, further comprising an application registration storage unit for storing the web service code generated by the ITCP execution plan generation unit.

4. The process-based inter-thing collaboration apparatus of claim 2, wherein the inter-thing collaboration management unit comprises:
an ITCP management engine unit for dynamically allocating things required to execute the web service code, and executing and monitoring the web service code; and
a web service broker unit for binding a suitable service to the web service code in response to a request received from the ITCP management engine unit, and calling and executing a corresponding service via a web service interface.

5. The process-based inter-thing collaboration apparatus of claim 4, wherein the ITCP management engine unit is implemented in a distributed structure having a plurality of engines to perform collaboration.

6. The process-based inter-thing collaboration apparatus of claim 2, wherein the ITCP specification is a BPMN process specification and is represented in a natural language or XML.

7. The process-based inter-thing collaboration apparatus of claim 2, wherein:
the web service code is Representational State Transfer (REST)ful web service code, and
the ITCP execution plan generation unit interprets the ITCP specification and then converts the ITCP specification into RESTful web service code written by a REST Application Programming Interface (API).

8. The process-based inter-thing collaboration apparatus of claim 1, further comprising a thing registration storage unit for storing metadata of the things, a thing context information storage unit for storing context information of the things, and a thing resource storage unit for storing resource information of the things.

9. The process-based inter-thing collaboration apparatus of claim 8, further comprising a thing recommendation unit for analyzing data of the thing registration storage unit and the thing context information storage unit and recommending things.

10. The process-based inter-thing collaboration apparatus of claim 8, further comprising a context awareness unit for providing context information of the things to the inter-thing collaboration management unit with reference to data of the thing context information storage unit.

11. The process-based inter-thing collaboration apparatus of claim 8, wherein the thing registration storage unit has a data structure represented by a form of an Entity-Relationship (E-R) model, wherein the E-R model includes thing entity including device and virtual thing and having multiple resources, wherein the device entity includes sensor and actuator, and the virtual thing entity includes service and process, and wherein the service entity includes identifier (ID), function, input, and output attributes, the process entity includes ID, name, function, and flow attributes, and a task entity includes ID, function, input, and output attributes, and link to a task to be subsequently executed, and wherein the process entity and the task entity access the thing entity via the service entity.

12. The process-based inter-thing collaboration apparatus of claim 8, wherein the thing context information storage unit has a data structure represented by a form of an E-R model, wherein the E-R model includes a community entity having multiple members, each having context entity, wherein information of context includes 5 W (who, what, when, where and why) and rules for processing the 5 W information.

13. The process-based inter-thing collaboration apparatus of claim 8, wherein the thing resource storage unit has a data structure having a form of a resource tree represented by a Uniform Resource Identifier (URI), wherein the resource tree includes thing resources having multiple thing-ID resources as children, the thing resources include device resource, service resource, and process resource implemented in a form of a tree structure on the plurality of thing-ID resources, and the process resource includes task resource and event resource, and
the device resource, the service resource, the process resource, the task resource, and the event resource are connected via hyperlink.

14. The process-based inter-thing collaboration apparatus of claim 1, wherein the inter-thing collaboration community includes a plurality of things required to execute the ITCP, and is configured such that a group allocated to a task of the ITCP is bound as things with reference to context information of the things.

15. A process-based inter-thing collaboration method in a WoT environment, comprising:
designing, by an inter-thing collaboration design tool unit, an ITCP based on information of things including a device, a service, and a process; and
dynamically configuring, by an inter-thing collaboration management unit, an inter-thing collaboration community based on context information of the things, and executing the ITCP.

16. The process-based inter-thing collaboration method of claim 15, wherein designing the ITCP comprises:
modeling the ITCP and then generating an ITCP specification; and
interpreting the ITCP specification and then generating web service code.

17. The process-based inter-thing collaboration method of claim 16, wherein dynamically executing the ITCP comprises:
dynamically allocating the things based on metadata of the things and the context information of the things;
authenticating the dynamically allocated things and then configuring the inter-thing collaboration community;
executing and monitoring the web service code within a space of the inter-thing collaboration community; and
binding a suitable service to the web service code in response to a request received at monitoring, and calling and executing a corresponding service through a web service interface.

18. The process-based inter-thing collaboration method of claim 15, wherein the inter-thing collaboration community includes a plurality of things required to execute the ITCP, and is configured such that a group allocated to a task of the ITCP is bound as things with reference to context information of the things.
